(19) United States
(12) Patent Application Publication
(10) Pub. No.: US 2007/0171904 A1
(43) Pub. Date: Jul. 26, 2007

(54) Traffic separation in a multi-stack computing platform using VLANs

(75) Inventor: Izoslav Tchigevsky, Kiryat Haim (IL)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/338,069

(22) Filed: Jan. 24, 2006

(51) Int. Cl. H04L 12/56; H04L 12/66

(52) U.S. Cl. 370/389; 370/463

(57) ABSTRACT

Embodiments of networking traffic separation mechanisms in a multi-stack computing platform using VLANs are described generally herein. Other embodiments may be described and claimed.

### TECHNICAL FIELD

Various embodiments described herein relate to digital communications generally, including apparatus, systems, and methods used in networking.

### BACKGROUND INFORMATION

A modern computing platform may be multi-partitioned. That is, two or more execution environments may coexist on the computing platform. Each execution environment may utilize some or all of the same platform resources as the other(s), and may be unaware of the existence of the other(s). These attributes may be referred to collectively as “virtualization” of the platform resources. As an example, a computing platform management partition may exist on the computing platform. The management partition may comprise hardware and/or software to enable information technology (IT) personnel to remotely manage the platform in a corporate environment. The management partition may be independent of and protected from the platform user and from user applications.

A partition such as the management partition cited in the example above may maintain its own network stack independent of a networking stack maintained by a primary operating system executing in another partition. Both stacks, or a plurality thereof, may access one or more wired or wireless network interface controllers (NICs) on the platform. The plurality of network stacks may share platform networking resources by sharing a single media access control (MAC) address and a single Internet protocol (IP) address. In this “shared IP” mode, traffic associated with a particular partition may be segregated from traffic associated with other partitions by using a particular transfer control protocol (TCP) port number for each.

Shared IP mode may thus provide a single point of access for traffic to all partitions. This may eliminate the need for separate network infrastructure for each partition. On the other hand, shared IP mode may impede network access to processes running in a higher-priority partition. If the primary operating system partition is non-functional, for example, IT personnel may be unable to access the platform management partition to perform a repair.

An alternative is to have separate MAC and IP addresses for each networked partition. Such “dedicated MAC” or “multi-MAC” mode of operation may present multiple interfaces to a network attached to the computing platform. The computing platform may appear to a wired network as two or more NICs connected to an internal hub. The computing platform may appear to a wireless access point as two or more independent stations.

Multi-MAC mode may increase a robustness of network connectivity associated with a high-priority partition such as a platform management partition or a security-related partition, as previously described. Disadvantages of multi-MAC mode operation may include the additional expense and complexity associated with duplicate networking resources, particularly hardware resources. Duplication of wireless networking resources may be especially costly, considering hardware and maintenance costs and increased consumption of spectral resources.

### BRIEF DESCRIPTION OF THE DRAWINGS

FIG. 1 is a block diagram of an apparatus and a representative system according to various embodiments.

FIGS. 2 and 3 are flow diagrams illustrating several methods according to various embodiments.

FIG. 4 is a block diagram of an article according to various embodiments.

### DETAILED DESCRIPTION

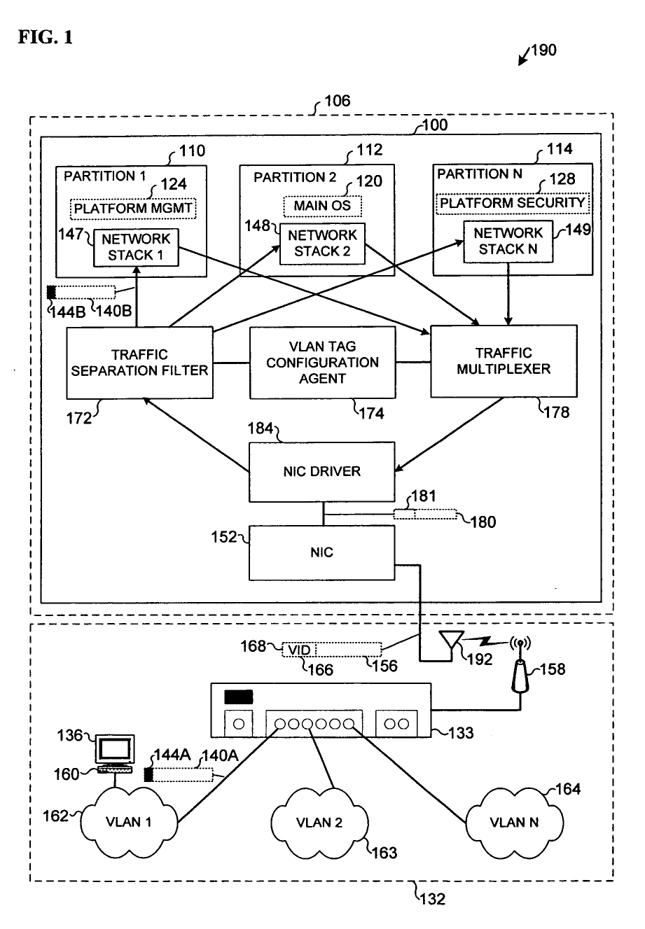

FIG. 1 comprises a block diagram of an apparatus 100 and a system 190 according to various embodiments of the invention. The apparatus 100 may be associated with a multi-partitioned computing platform 106. The platform 106 may include two or more partitions, shown in FIG. 1 as partitions 110, 112, and 114. Some embodiments may comprehend a greater or lesser number of partitions. In some embodiments, one of the partitions 110, 112, and 114, e.g., the partition 112, may be designated as a main user partition. The main user partition may execute a main operating system (OS) 120. Another partition, e.g., the partition 110, may execute a platform management agent 124. A third partition, e.g., the partition 114, may execute a platform security application 128. These partitions and applications are merely examples. Various embodiments may comprise other configurations.

Some embodiments may achieve advantages associated with multi-MAC operation using a single networking link between the platform 106 and a network 132 serving the platform 106. Traffic separation and routing may be achieved through the use of virtual local area network (VLAN) techniques. The VLAN techniques may control traffic flow between the partitions associated with the computing platform 106 and a plurality of VLANs on the network 132. The plurality of VLANs may be implemented with networking equipment associated with the network 132, including perhaps a packet switch 133. Suppose, for example, that network management staff wish to contact the platform management agent 124 from a management console 136. The management console 136 may tag each of the packets 140A and 140B with a VLAN header 144A and 144B, respectively. Mechanisms within the apparatus 100 may direct the packet 140B to the partition 110 based upon the VLAN header 144B. A packet directed to or originating from any of the partitions 110, 112, or 114 may be tagged with a partition-specific VLAN header to maintain traffic separation.

It is noted that an untagged packet may be distinguishable from a tagged packet merely because it is untagged. Thus, in some embodiments, packets associated with a single one of the partitions 110, 112, and 114 may traverse the VLAN-segmented network 132 untagged. For example, a network stack 148 associated with the main OS 120 may create packets without a VLAN header, and steering logic within the apparatus 100 may direct untagged inbound packets to the network stack 148. Inbound packets may be directed to the partitions 110 and 114 based upon respective VLAN headers associated with each of the partitions 110 and 114.

From a network infrastructure perspective, the computing platform 106 may be identified by a media access control (MAC) address. A particular partition may be identified by a combination of MAC address and VLAN address. Independent networking to a particular partition is thus enabled. In some embodiments, drivers appropriate to common network hardware and to the steering logic may execute from one or more of the partitions 110, 112, and 114. In other embodiments, these drivers may execute from firmware or from a special networking partition. In any case, embodiments herein may maintain a separation between networking functionality associated with the various partitions.

The apparatus 100 may include a network interface controller (NIC) 152 to receive an inbound packet 156. The NIC 152 may comprise a wired NIC, coupled to the network 132 by cable or optical fiber. Alternatively, the NIC 152 may comprise a wireless NIC communicatively coupled to a wireless access point 158 located on the VLAN-segmented network 132. As an example, the inbound packet 156 may originate at a node 160 on a VLAN 162 in the VLAN-segmented network 132. In order to cause the packet 156 to be switched to the NIC 152, the node 160 may insert a MAC address associated with the NIC 152 in the inbound packet 156.

The inbound packet 156 may also carry a VLAN header 166 containing a VLAN identification (VID) 168. The VID 168 may correspond to the VLAN 162 and to one of a plurality of network stacks 147, 148, and 149 on the computing platform 106. The NIC 152 may thus represent a gateway from the network 132 to the computing platform 106 generally and to the network stacks 147, 148, and 149 in particular.

The computing partitions 110, 112, and 114 on the computing platform 106 may be associated one-to-one to the plurality of network stacks 147, 148, and 149, as depicted in FIG. 1. The computing partitions 110, 112, and 114 may be communicatively coupled one-to-one to the plurality of VLANs associated thereto by a plurality of VIDs. The plurality of VLANs may comprise VLANs 162, 163, and 164, for example. An application module such as the platform management module 124 may execute within one of the plurality of computing partitions 110, 112, or 114. The application module may receive data from the inbound packet 156 and may transmit data to a chosen VLAN via the following mechanism.

A traffic separation filter 172 may be coupled to the NIC 152. The traffic separation filter 172 may examine the inbound packet 156 to determine the VID 168 embedded in the inbound packet 156. The traffic separation filter 172 may then switch the inbound packet 156 to one of the network stacks 147, 148, or 149 based upon the VID 168.

The apparatus 100 may include a VLAN tag configuration agent 174 coupled to the traffic separation filter 172. The VLAN tag configuration agent 174 may pre-assign the VID 168 at the computing platform 106. To “pre-assign” in this context means to assign the VID 168 prior to the receipt and/or transmission of network packets dependent for delivery upon mechanisms hereinafter described. The VID pre-assignment may be made via operator input or by software executing on the computing platform 106, among other methods. The VID pre-assignment may be made such that a chosen network stack is communicatively associated with a node on a VLAN (e.g., the network stack 147 may be communicatively associated with the node 160 on the VLAN 162). The VLAN may be defined by a network switching configuration associated with the network 132.

Outbound traffic may be directed using a traffic multiplexer 178 coupled to the NIC 152. The traffic multiplexer 178 may tag an outbound packet 180 to be transmitted from the NIC 152. The outbound packet 180 may be tagged with a VLAN header 181 containing the VID, wherein the VID corresponds to the network stack 147, 148, or 149 originating the outbound packet 180. The outbound packet 180 may be transmitted to the VLAN-segmented network 132. The VLAN-segmented network 132 may then deliver the outbound packet 180 to a destination MAC address associated with a node on a VLAN, wherein the VLAN corresponds to the VID. For example, the outbound packet 180 may be delivered to the node 160 on the VLAN 162.

The apparatus 100 may also include a NIC driver 184 coupled to the NIC 152. The NIC driver 184 may load configuration parameters into the NIC 152 and may receive status messages from the NIC 152. The NIC driver 184 may also pass data between the NIC 152 and one or more of the network stacks 147, 148, and 149, perhaps via the traffic separation filter 172 and the traffic multiplexer 178. The data may include the inbound packet 156, a portion of the inbound packet 156, the outbound packet 180, or a portion of the outbound packet 180.

In another embodiment, a system 190 may include one or more of the apparatus 100, as previously described. The system 190 may also include an antenna 192 coupled to the NIC 152 to communicatively couple the NIC 152 to the wireless access point 158 on the VLAN-segmented network 132. The antenna 192 may comprise a patch, omnidirectional, beam, monopole, or dipole, among other types.

Any of the components previously described can be implemented in a number of ways, including embodiments in software. Thus, the apparatus 100; computing platform 106; partitions 110, 112, 114; operating system 120; platform management agent 124; platform security application 128; network 132; packet switch 133; management console 136; packets 140A, 140B, 156, 180; VLAN headers 144A, 144B; network stacks 147, 148, 149; network interface controller (NIC) 152; wireless access point 158; node 160; virtual local-area networks (VLANs) 162, 163, 164; VLAN headers 166, 181; VLAN identification (VID) 168; traffic separation filter 172; VLAN tag configuration agent 174; traffic multiplexer 178; NIC driver 184; system 190; and antenna 192 may all be characterized as “modules” herein.

The modules may include hardware circuitry, single or multi-processor circuits, memory circuits, software program modules and objects, firmware, and combinations thereof, as desired by the architect of the apparatus 100 and the system 190 and as appropriate for particular implementations of various embodiments.

The apparatus and systems of various embodiments may be useful in applications other than maintaining separate network traffic streams to individual computing partitions on a multi-partitioned computing platform using a common network interface. Thus, various embodiments of the invention are not to be so limited. The illustrations of the apparatus 100 and the system 190 are intended to provide a general understanding of the structure of various embodiments. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

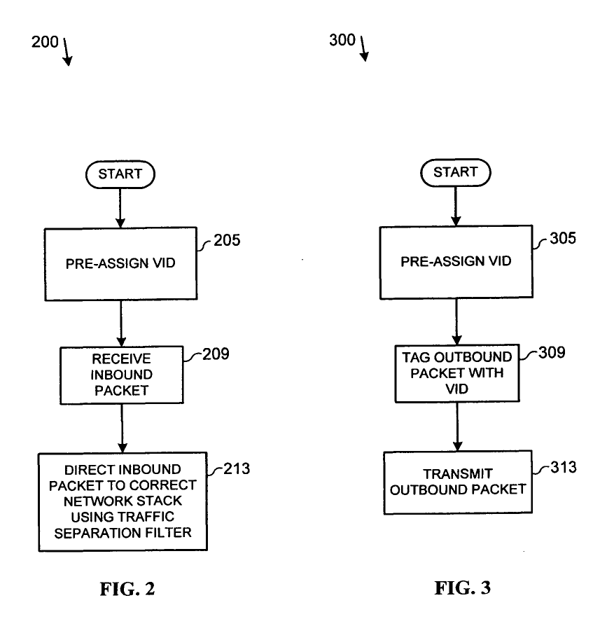

FIG. 2 is a flow diagram illustrating several methods according to various embodiments. The methods may operate to associate each of a plurality of partitions in a multi-partition computing platform with a corresponding one of a plurality of VLANs in a VLAN-segmented network external to the computing platform. In some embodiments, the VLAN-segmented network may operate according to an Institute of Electrical and Electronic Engineers (IEEE) 802.1Q protocol. Additional information regarding the IEEE 802.1Q standard may be found in IEEE Standard 802.1Q™, IEEE Standards for Local and Metropolitan Area Networks—Virtual Bridged Local Area Networks (published May 7, 2003). The method and apparatus described herein are not limited in this regard.

A plurality of network stacks on the computing platform may also be associated on a one-to-one basis with the plurality of computing partitions. Network traffic between a partition and a corresponding VLAN may thus be isolated to that particular partition/VLAN pair, as previously described.

A network stack may also be associated with one or more software applications, or class of applications executing in a partition on the computing platform. For example, a first partition may comprise a primary operating system partition. A second partition may comprise a computing platform management partition, including perhaps a remotely-managed platform management agent, or a partition dedicated to platform security, for example.

A method 200 may begin at block 205 with pre-assigning a VID at the multi-partition computing platform using a VLAN tag configuration agent. To “pre-assign” in this context means to assign the VID prior to the receipt and/or transmission of network packets dependent for delivery upon activities hereinafter described. The VID may be assigned such that a first network stack is communicatively associated with a first VLAN. That is, a packet tagged with the VID may be switched within the network using the VID such that the packet travels between the first network stack and the first VLAN.

The method 200 may continue with receiving an inbound packet at a NIC on the computing platform, at block 209. The NIC may comprise a wired, optically coupled, or wireless NIC. In the latter case the inbound packet may be received from a wireless access point located on the VLAN-segmented network. The inbound packet may have originated at a node on a VLAN, including perhaps a node on the first VLAN. The originating node may have inserted into the inbound packet a destination MAC address corresponding to a MAC address associated with the NIC. The originating node may also have inserted into the inbound packet a VID corresponding to the originating VLAN in the VLAN-segmented network.

The inbound packet may thus have a VLAN header containing a VID corresponding to the originating VLAN, including perhaps the first VLAN. The VID may also correspond to one of the plurality of network stacks on the computing platform, including perhaps the first network stack. The method 200 may conclude with directing the inbound packet to the network stack corresponding to the VID using a traffic separation filter, at block 213.

A method 300 may include activities associated with network traffic outbound from the computing platform. The method 300 may begin at block 305 with pre-assigning a VID at the multi-partition computing platform using a VLAN tag configuration agent. The method 300 may continue at block 309 with tagging an outbound packet with a VLAN header containing the VID. A traffic multiplexer as previously described or similar structures may be used for this purpose. The traffic multiplexer may tag the outbound packet such that the VID corresponds to the network stack originating the outbound packet.

The method 300 may conclude with transmitting the outbound packet from the NIC to the VLAN-segmented network, at block 313. The outbound packet may be delivered to a destination MAC address associated with a node on a VLAN, wherein the VLAN corresponds to the VID.

It may be possible to execute the activities described herein in an order other than the order described. And, various activities described with respect to the methods identified herein can be executed in repetitive, serial, or parallel fashion.

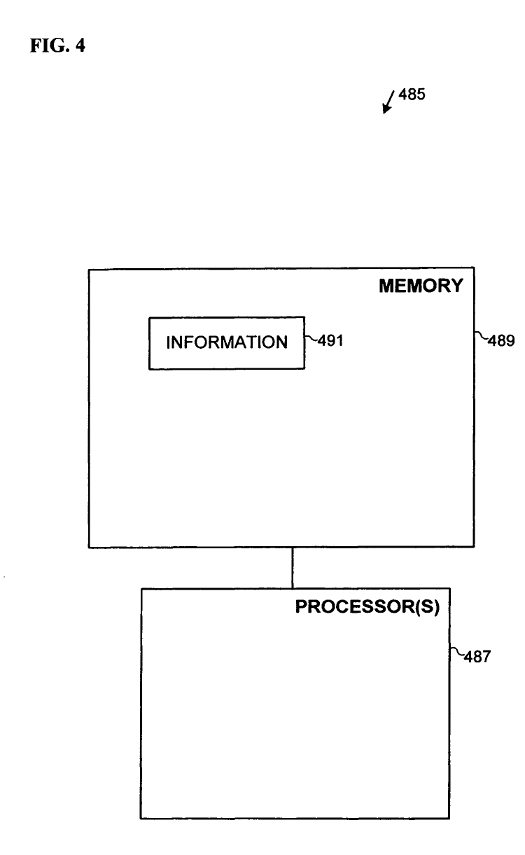

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 4 below.

FIG. 4 is a block diagram of an article 485 according to various embodiments of the invention. Examples of such embodiments may comprise a computer, a memory system, a magnetic or optical disk, some other storage device, or any type of electronic device or system. The article 485 may include one or more processor(s) 487 coupled to a machine-accessible medium such as a memory 489 (e.g., a memory including electrical, optical, or electromagnetic elements). The medium may contain associated information 491 (e.g., computer program instructions, data, or both) which, when accessed, results in a machine (e.g., the processor(s) 487) performing the activities previously described.

Implementing the apparatus, systems, and methods disclosed herein may achieve advantages of a multi-MAC mode of operation by maintaining separate networking identities for each of several partitions within a computing platform. Networking infrastructure overhead may also be reduced, because a single NIC may be capable of processing the resulting multiple data streams. In a wireless case, a single wireless link may simplify the wireless security model and may reduce cost and complexity of the networking hardware compared to operation using multiple wireless links.

Although the inventive concept may include embodiments described in the exemplary context of an IEEE standard 802.xx implementation (e.g., 802.11, 802.11a, 802.11b, 802.11g, 802.16, etc.), the claims are not so limited. Additional information regarding the IEEE 802.11 protocol standard may be found in ANSI/IEEE Std 802.11, Information technology—Telecommunications and information exchange between systems—Local and metropolitan area networks—Specific requirements—Part 11: Wireless LAN Medium Access Control (MAC) and Physical Layer (PHY) Specifications (reaffirmed Jun. 12, 2003). Additional information regarding the IEEE 802.11a protocol standard may be found in IEEE Std 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band (published 1999; reaffirmed Jun. 12, 2003). Additional information regarding the IEEE 802.11b protocol standard may be found in IEEE Std 802.11b, Supplement to IEEE Standard for Information technology—Telecommunications and information exchange between systems—Local and metropolitan area networks—Specific requirements—Part 11: Wireless LAN Medium Access Control (MAC) and Physical Layer (PHY) specifications: Higher-Speed Physical Layer Extension in the 2.4 GHz Band (approved Sep. 16, 1999; reaffirmed Jun. 12, 2003). Additional information regarding the IEEE 802.11g protocol standard may be found in IEEE Std 802.11g™, IEEE Std 802.11g™, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band (approved Jun. 12, 2003). Additional information regarding the IEEE 802.16 protocol standard may be found in IEEE Standard for Local and Metropolitan Area Networks—Part 16: Air Interface for Fixed Broadband Wireless Access Systems (2004).

Embodiments of the present invention may be implemented as part of any wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method, including:
receiving an inbound packet at a network interface controller (NIC), the inbound packet having a virtual local-area network (VLAN) header containing a VLAN identification (VID), the VIED corresponding to one of a plurality of network stacks on a computing platform associated with the NIC; and
directing the inbound packet to the one of the plurality of network stacks corresponding to the VID using a traffic separation filter.

2. The method of claim 1, wherein the inbound packet originates from a node on a VLAN, the VLAN corresponding to the VID in a VLAN-segmented network, the node on the VLAN having inserted into the inbound packet a destination MAC address corresponding to a MAC address associated with the NIC.

3. The method of claim 2, wherein the NIC comprises a wireless NIC and wherein the inbound packet is received at the wireless NIC from a wireless access point located on the VLAN-segmented network.

4. The method of claim 2, further including:
pre-assigning the VID at the computing platform using a VLAN tag configuration agent such that the one of the plurality of network stacks is communicatively associated with the node on the VLAN.

5. The method of claim 1, further including:
tagging an outbound packet with a VLAN header containing the VID using a traffic multiplexer, wherein the VID corresponds to the one of the plurality of network stacks.

6. The method of claim 5, further including:
transmitting the outbound packet from the NIC to a VLAN-segmented network capable of delivering the outbound packet to a destination media access control (MAC) address associated with a node on a VLAN, wherein the VLAN corresponds to the VID.

7. The method of claim 6, wherein the VLAN-segmented network operates according to an Institute of Electrical and Electronic Engineers 802.1q protocol.

8. The method of claim 1, wherein the plurality of network stacks is associated on a one-to-one basis with a plurality of computing partitions on the computing platform.

9. The method of claim 8, wherein a first partition selected from the plurality of computing partitions comprises a primary operating system partition and a second partition selected from the plurality of computing partitions comprises a computing platform management partition.

10. The method of claim 1, wherein one of the plurality of network stacks is associated with at least one software application executing in a partition on the computing platform.

11. An article including a machine-accessible medium having associated information, wherein the information, when accessed, results in a machine performing:
receiving an inbound packet at a network interface controller (NIC), the inbound packet having a VLAN header containing a VLAN identification (VID), the VID corresponding to one of a plurality of network stacks on a computing platform associated with the NIC; and
directing the inbound packet to the one of the plurality of network stacks corresponding to the VID using a traffic separation filter.

12. The article of claim 11, wherein the inbound packet originates at a node on a VLAN, the VLAN corresponding to the VID in a VLAN-segmented network, the node on the VLAN having inserted into the inbound packet a destination MAC address corresponding to a MAC address associated with the NIC.

13. The article of claim 12, wherein the information, when accessed, results in a machine performing:
pre-assigning the VID at the computing platform using a VLAN tag configuration agent such that the one of the plurality of network stacks is communicatively associated with the node on the VLAN.

14. The article of claim 11, wherein the information, when accessed, results in a machine performing:
tagging an outbound packet with a VLAN header containing the VID using a traffic multiplexer, wherein the VID corresponds to the one of the plurality of network stacks.

15. The article of claim 14, further including:
transmitting the outbound packet from the NIC to a VLAN-segmented network capable of delivering the outbound packet to a destination media access control (MAC) address associated with a node on a VLAN, wherein the VLAN corresponds to the VID.

16. An apparatus, including:
a network interface controller (NIC) to receive an inbound packet with a VLAN header containing a VLAN identification (VID), the VID corresponding to one of a plurality of network stacks on a computing platform associated with the NIC; and
a traffic separation filter coupled to the NIC to direct the inbound packet to the one of the plurality of network stacks corresponding to the VID.

17. The apparatus of claim 16, wherein the inbound packet originates at a node on a VLAN, the VLAN corresponding to the VID in a VLAN-segmented network, the node on the VLAN having inserted into the inbound packet a destination MAC address corresponding to a MAC address associated with the NIC.

18. The apparatus of claim 17, further including:
a VLAN tag configuration agent coupled to the traffic separation filter to pre-assign the VID at the computing platform such that the one of the plurality of network stacks is communicatively associated with the node on the VLAN.

19. The apparatus of claim 16, further including:
a traffic multiplexer coupled to the NIC to tag an outbound packet to be transmitted from the NIC with a VLAN header containing the VID, wherein the VID corresponds to the one of the plurality of network stacks.

20. The apparatus of claim 19, wherein the outbound packet is to be transmitted to a VLAN-segmented network capable of delivering the outbound packet to a destination media access control (MAC) address associated with a node on a VLAN, wherein the VLAN corresponds to the VID.

21. The apparatus of claim 20, wherein the NIC comprises a wireless NIC communicatively coupled to a wireless access point located on the VLAN-segmented network.

22. The apparatus of claim 16, further including:
a plurality of computing partitions on the computing platform, the plurality of computing partitions communicatively coupled one-to-one to the plurality of network stacks.

23. The apparatus of claim 22, further including:
an application module to execute within one of the plurality of computing partitions and to receive data from the inbound packet, wherein the one of the computing partitions is communicatively coupled to the one of the plurality of network stacks.

24. The apparatus of claim 23, wherein the application module comprises a computing platform manager.

25. The apparatus of claim 16, further including:
a NIC driver coupled to the NIC to perform at least one of loading configuration parameters into the NIC, receiving status messages from the NIC, or passing at least one of the inbound packet, a portion of the inbound packet, an outbound packet, or a portion of the outbound packet between the NIC and the one of the plurality of network stacks.

26. A system, including:
a network interface controller (NIC) to receive an inbound packet with a VLAN header containing a VLAN identification (VID), the VID corresponding to one of a plurality of network stacks on a computing platform associated with the NIC;
a traffic separation filter coupled to the NIC to direct the inbound packet to the one of the plurality of network stacks corresponding to the VID; and
an omni-directional antenna coupled to the NIC to communicatively couple the NIC to a wireless access point on a VLAN-segmented network.

27. The system of claim 26, wherein the inbound packet originates at a node on a VLAN, the VLAN corresponding to the VID in the VLAN-segmented network, the node on the VLAN having inserted into the inbound packet a destination MAC address corresponding to a MAC address associated with the NIC.

28. The system of claim 27, further including:
a VLAN tag configuration agent coupled to the traffic separation filter to pre-assign the VID at the computing platform such that the one of the plurality of network stacks is communicatively associated with the node on the VLAN.

29. The system of claim 26, further including:
a traffic multiplexer coupled to the NIC to tag an outbound packet to be transmitted from the NIC with a VLAN header containing the VID, wherein the VID corresponds to the one of the plurality of network stacks.

30. The system of claim 29, wherein the outbound packet is to be transmitted to a VLAN-segmented network capable of delivering the outbound packet to a destination media access control (MAC) address associated with a node on a VLAN, wherein the VLAN corresponds to the VID.
